(19) United States
(12) Patent Application Publication
(10) Pub. No.: US 2019/0186907 A1
(43) Pub. Date: Jun. 20, 2019

(54) MULTI-DIMENSIONAL MEASUREMENT SYSTEM FOR PRECISE CALCULATION OF POSITION AND ORIENTATION OF A DYNAMIC OBJECT

(71) Applicant: AP Robotics, LLC., Rockville, MD (US)

(72) Inventors: Kan C. Lau, Potomac, MD (US); Henry Song, Annandale, VA (US); Yubing Yang, Potomac, MD (US); Yuangun Liu, North Potomac, MD (US)

(73) Assignee: AP Robotics, LLC., Rockville, MD (US)

(21) Appl. No.: 16/222,329

(22) Filed: Dec. 17, 2018

Related U.S. Application Data
(60) Provisional application No. 62/599,788, filed on Dec. 17, 2017.

(51) Int. Cl. G01B 11/26

(52) U.S. Cl. CPC G01B 11/26

(57) ABSTRACT

A measurement system is described herein that accurately calculates the complete position and orientation of a dynamic object in real-time. The measurement system includes a laser unit, a target, a camera unit, and a control unit. The target is arranged to rotate about all three spatial axes, and includes a reflective element, a gyroscope, and a pair of light emitting devices. The laser unit is arranged to rotate about two of its spatial axes, and further arranged to emit a laser beam toward the target. The reflective element reflects the laser beam back toward the laser unit, where the laser unit detects the returned laser beam. The camera unit is arranged to detect light emitted from the pair of light emitting devices. The control unit is arranged to gather information and data captured by the system to determine the position and orientation of the object.

### RELATED APPLICATIONS

This application claims the benefit of U.S. Provisional Application No. 62/599,788 filed on Dec. 17, 2017, the entire contents of which are incorporated herein by reference.

### FIELD OF INVENTION

The present disclosure generally relates to systems and methods for gathering information and data for the calculation of the position and orientation of an object. More specifically, the present disclosure relates to a multi-dimensional measurement system for gathering data and information for the precise calculation of the position and orientation of a dynamic object, where multiple measurements are collected to adjust for error to more precisely calculate the position and orientation of the dynamic object.

### BACKGROUND

In many of life's endeavors, it is useful to accurately measure and determine the precise position and orientation of objects. Accurate position and orientation measurements are useful and even critical in many areas such as manufacturing, industrial research and development, product development, and academic research. There are current systems that are used to determine the position and/or orientation of objects. Such systems can be of varying sophistication, with some systems limited to determining the spatial position of an object (i.e., the object's position within three dimensional space), but cannot determine the rotational orientation of the object (i.e., the object's rotation about its three spatial axes, commonly referred to as yaw, pitch and roll axes). Such systems are often referred to as three-dimensional measurement systems. More sophisticated systems can additionally measure an object's rotational orientation about two of the special axes, commonly the yaw and pitch axes. Such systems are often referred to as five-dimensional measurement systems. Even more sophisticated systems can additionally measure an object's rotational positioning about all three spatial axes. Such systems are often referred to as six-dimensional measurement systems. Determining both an object's spatial position and complete orientation is commonly referred to as measuring six-degrees of freedom of the object.

Measurement systems can be arranged to use laser beams to determine the position of an object. Such systems typically include a laser-emitting device for emitting laser beams toward the object, one or more reflective elements that are attached to the object to reflect the laser beam, and a laser-detecting device to detect the reflected laser beam. The laser-emitting device and the laser-detecting device are commonly coupled together into one device. The laser-emitting/detecting device is typically secured in a static position such as positioned on a bench or a tri-pod that provides an unobstructed view of the object to be measured. The laser-emitting/detecting device is typically allowed some degree of rotation about two spatial axes so that it can follow the object as it moves. The reflective elements are attached to the object and are arranged to reflect a laser beam back in the direction from which the laser beam is emitted. The laser-emitting/detecting device detects the reflected laser beam and gathers the characteristics of the laser beam, such as flight time and the angles at which the laser beam is emitted and returned. Through mathematical and geometric calculations, the measurement system can determine certain aspects of the position of the object.

Such measurement systems have a wide variety of applications. For example, in robotic manufacturing, accurately locating and orienting robotic components is often required. Accurately tracking the movement of robotic components and adjusting the component's position and orientation when needed can be critical to manufacturing quality products. Current measurement systems are prone to inaccuracies in the measurement of an object's orientation, this is especially so when the object undergoes substantial rotation about its spatial axes. There is a need for improvements to existing measurement systems to provide for accurate and precise position and orientation measurements of a dynamic object.

### SUMMARY

In one embodiment, a measurement system is provided that accurately calculates the complete position and orientation of a dynamic object in real-time. The measurement system includes a laser unit, a target, a control unit, and a mechanism for contributing to the measurement of rotation about the roll axis. The target is arranged to rotate about all three spatial axes, and includes a reflective element and a gyroscope. The target is attached to the object for which position will be calculated. The laser unit is arranged to rotate about two of its spatial axes, and further arranged to emit a laser beam toward the target attached to the object. The reflective element of the target reflects the laser beam back toward the laser unit, where the laser unit detects the returned laser beam. In certain embodiments, more than one target can be attached to the object.

The laser unit and the target are arranged such that when the laser beam is directed toward the target, the system continuously adjusts so that the surface of the reflective element of the target remains perpendicular to the path of the laser beam. The system gathers information on the rotational position of the laser unit and the flight time of the laser beam from the laser unit to the target and back. From this information, the control unit can calculate the spatial position (i.e., the Cartesian coordinates) of the target, which is translated into the spatial position of the object. The system gathers information on the rotational orientation of the target in the form of data generated by servo motors and encoders included in the target. From this servo motor and encoder data, the control unit can calculate the rotational orientation about the yaw and pitch axes of the target, which is translated into the rotational orientation of the object about the yaw and pitch axes.

With regard to the rotational orientation about the roll axis, the system gathers information generated by the gyroscope and an additional mechanism. In one embodiment, the additional mechanism comprises a pair of light emitting devices spaced apart from each other and attached to the target and the camera unit positioned to capture images of the target and generate data about the target. From the data generated by the gyroscope and camera unit, the control unit can calculate the rotational orientation of the target about the roll axis, which is translated into the rotational orientation of the object about the roll axes. The system is arranged such that it generally relies on the data from the gyroscope to determine rotational orientation about the roll axis. Additionally, the system relies on information gathered by the camera to adjust for any drift experienced by the gyroscope. The light emitting devices are spaced apart such that each experiences opposite vertical and horizontal displacement when the target experiences roll. The camera senses the light emitted by the pair of light emitting devices and can map the relative vertical and horizontal displacements of the light emitting devices. From such vertical and horizontal displacement, the control unit can calculate the roll of the target and provide any required correction or adjustments to the orientation calculated from data gathered from the gyroscope.

In another embodiment, the additional mechanism comprises one or more levels incorporated into the target, which generate data about the target. From the data generated by the gyroscope and level, the control unit can calculate the rotational orientation of the target about the roll axis, which is translated into the rotational orientation of the object about the roll axis. Again, the system is arranged such that it generally relies on the data from the gyroscope to determine rotational orientation about the roll axis. The system relies on information gathered by a plurality of MEMS levels to determine rotation about the roll axis when the target is in a static state and to adjust for any drift experienced by the gyroscope during dynamic movement. The plurality of levels are positioned within the target such that at least one of the levels can determine the rotational orientation about the roll axis through the entire 360 degree path about the roll axis. From such a determination, the system can make any correction or adjustments to the rotational orientation calculated from data gathered from the gyroscope.

Thus, the multi-dimensional measurement systems disclosed herein can accurately calculate the complete position and rotational orientation (i.e., six-degrees of freedom) of a dynamic object in real-time.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 schematically illustrates a perspective view of an exemplary multi-dimensional measurement system in accordance with this disclosure.

FIG. 2 schematically illustrates a perspective view of an exemplary target for use with the multi-dimensional measurement system of FIG. 1.

FIG. 3 schematically illustrates an exemplary perspective view of a gyroscope and a pair of light emitting devices mounted to a shaft for use with the target of FIG. 2;

FIG. 4 schematically illustrates a perspective view of the target of FIG. 2 with the top removed;

FIG. 5 schematically illustrates a front-left perspective view of another exemplary multi-dimensional measurement system in accordance with this disclosure.

FIG. 6 schematically illustrates a front-right perspective view of the multi-dimensional measurement system of FIG. 5.

FIG. 7 schematically illustrates a front-left perspective view of yet another exemplary multi-dimensional measurement system in accordance with this disclosure.

FIG. 8 schematically illustrates a front-right perspective view of the multi-dimensional measurement system of FIG. 7.

FIG. 9 schematically illustrates an exemplary perspective view of a target located in a known initial position for use with multi-dimensional measurement systems as disclosed herein.

FIG. 10 schematically illustrates a front elevation view of the target of FIG. 9.

FIG. 11 schematically illustrates the target of FIG. 9 rotated about the roll axis away from its initial position.

FIG. 12 schematically illustrates the target of FIG. 9 rotated about the roll axis away from its initial position.

FIG. 13 schematically illustrates the target of FIG. 9 rotated about the roll axis away from its initial position.

FIG. 14 schematically illustrates the target of FIG. 9 rotated about the roll axis away from its initial position.

FIG. 15 schematically illustrates an arrangement for the placement of three levels within a target for use with multi-dimensional measurement systems as disclosed herein, where the target is located in its known initial position.

FIG. 16 schematically illustrates the arrangement of FIG. 15 rotated about the roll axis away from its initial position.

FIG. 17 schematically illustrates the arrangement of FIG. 15 rotated about the roll axis away from its initial position.

FIG. 18 schematically illustrates the arrangement of FIG. 15 rotated about the roll axis away from its initial position.

FIG. 19 schematically illustrates the arrangement of FIG. 15 rotated about the roll axis away from its initial position.

FIG. 20 schematically illustrates the arrangement of FIG. 15 rotated about the roll axis away from its initial position.

FIG. 21 schematically illustrates the arrangement of FIG. 15 rotated about the roll axis away from its initial position.

FIG. 22 schematically illustrates the arrangement of FIG. 15 rotated about the roll axis away from its initial position.

FIG. 23 schematically illustrates the arrangement of FIG. 15 rotated about the roll axis away from its initial position.

FIG. 24 schematically illustrates another arrangement for the placement of three levels within a target for use with multi-dimensional measurement systems as disclosed herein.

FIG. 25 schematically illustrates an arrangement for the placement of one level within a target for use with multi-dimensional measurement systems as disclosed herein.

FIG. 26 schematically illustrates an arrangement for the placement of a pair of levels within a target for use with multi-dimensional measurement systems as disclosed herein.

### DETAILED DESCRIPTION

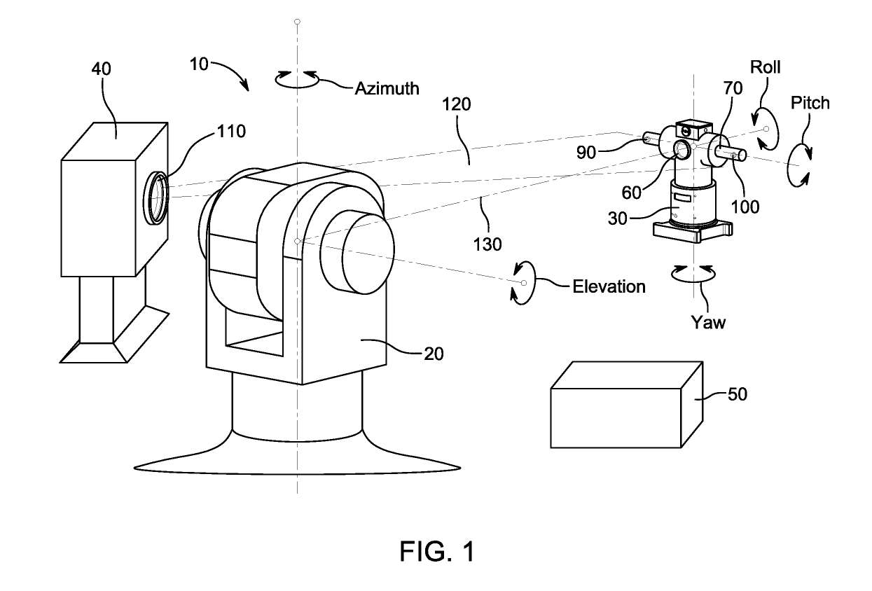

The apparatus, systems, arrangements, and methods disclosed in this document are described in detail by way of examples and with reference to the figures. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for accurately calculating the complete position and orientation of a dynamic object in real-time are hereinafter disclosed and described in detail with reference made to FIGS. 1-26.

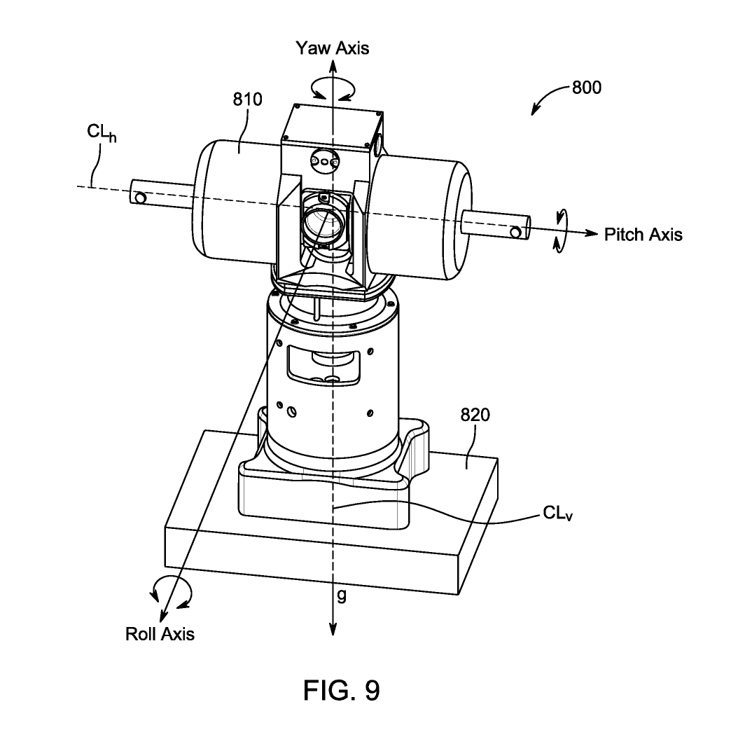

As will be described in detail herein, the multi-dimensional measurement systems and methods for using such measurement systems disclosed herein provide for novel apparatus and methods for accurately determining the complete position and rotational orientation of a dynamic object in real-time. In one embodiment, the multi-dimensional measurement system calculates the rotational orientation of the dynamic object in part through the combined use of a gyroscope, a pair of light emitting devices, and a camera unit that is sensitive to the light emitted from the pair of light emitting devices. In another embodiment, the multi-dimensional measurement system calculates the rotational orientation of the dynamic object in part through the combined use of a gyroscope and one or more sensors arranged to determine an orientation angle with respect to the force of gravity. Such sensors, which can be referred to, for example, as inclinometers, tilt sensors, or slope sensors, will be referred to herein as “levels” for convenience of description. Levels and methods of using levels will be further discussed with reference to FIGS. 9-25. In yet another embodiment, the multi-dimensional measurement system calculates the rotational orientation of the dynamic object in part through the combined use of a gyroscope, a pair of light emitting devices, a camera unit that is sensitive to the light emitted from the pair of light emitting devices, and one or more levels.

The various components of an exemplary multi-dimensional measurement system will be first described in detail, followed by a detailed description of how such various components interact to provide the system with the data and information required to calculate the complete position and rotational orientation (i.e., six degrees of freedom) of a tracked dynamic object in real-time. For clarity, the term “dynamic object” as used herein refers to an object that can move positionally (i.e., with respect to the Cartesian coordinate system) as well as rotationally about its three spatial axis (yaw, pitch, and roll).

FIG. 1 illustrates an exemplary multi-dimensional measurement system 10. The measurement system 10 includes a laser unit 20, a target 30, a camera unit 40, and a control unit 50. Although these components are illustrated and described as discrete components, it will be understood that one or more of the disclosed components can be combined into a single component. For example, the laser unit 20 and the camera unit 40 can be combined into one component, the laser unit 20 and control unit 50 can be combined into one component, or the laser unit 20, camera unit 40, and control unit 20 can all be combined into one component. Conversely, components that are illustrated or described with multiple functionalities can be separated into multiple discrete components.

The laser unit 20 is arranged to emit a laser beam (“outgoing laser beam”) and detect that laser beam when it is reflected back (“incoming laser beam”) toward the laser unit 20. The laser unit 20 is arranged so that it can rotate about two spatial axis. It will be understood that the terms “spatial axis” or “spatial axes” as used herein refer to one or more of the axis of the traditional Cartesian coordinate system, which provides three perpendicular axes as a reference for three dimensional geometry. As illustrated in FIG. 1, the first spatial axis of rotation for the laser unit 20 is about a vertical line (hereinafter referred to azimuth) passing through the laser unit 20, and the second spatial axis of rotation is about a horizontal line (hereinafter referred to as elevation) passing through the laser unit 20. Such rotational movement allows for the laser unit 20 to emit a laser beam in many different directions and, thus, follow the target 30 as it moves along with the object.

The laser unit 20 includes a number of servo motors to rotate the laser unit 20 about the azimuth and elevation axes. The laser unit 20 also includes a number of encoders to measure the rotation of the laser unit 20 about the azimuth and elevation axes. The laser unit 20 is arranged such that when it emits an outgoing laser beam, and subsequently receives the reflected incoming laser beam, the laser unit 20 can detect and capture information and data regarding the characteristics of the outgoing and incoming laser beams. Such information and data includes, for example, the time of flight between when the outgoing laser beam was emitted and when the incoming laser beam was detected and the angles of the outgoing and incoming laser beams as compared to the laser unit 20. As will be explained in further detail herein, the information and data gathered by the laser unit 20 can be useful in calculating the position of the an object with respect to the traditional Cartesian coordinate system.

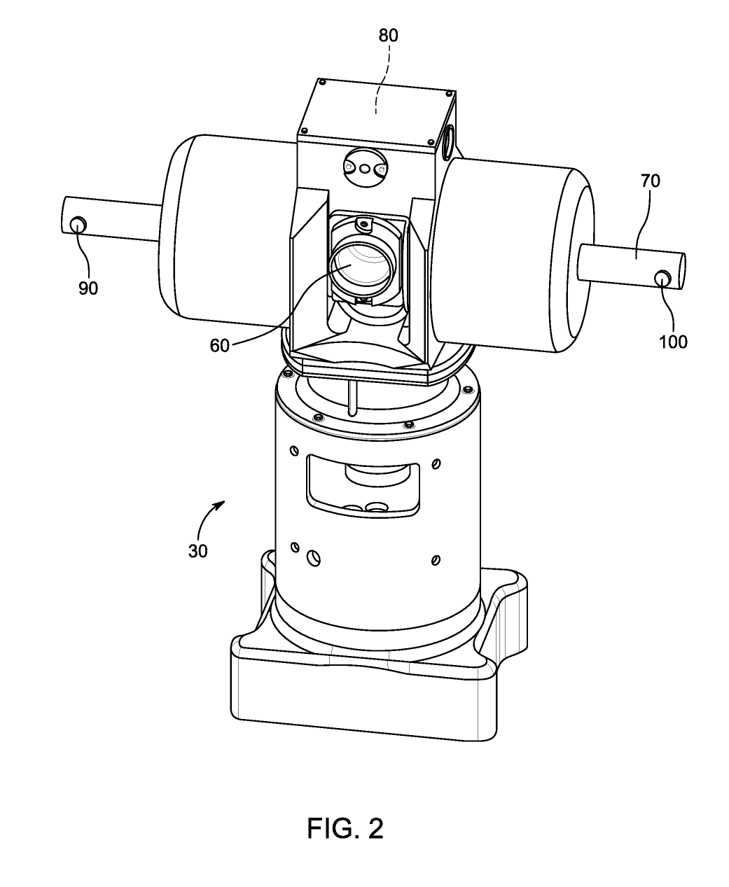

As illustrated in FIGS. 1 and 2, the target 30 includes a reflective element 60, a central shaft 70 passing through the target 30, a gyroscope 80 positioned within the target 30 and secured to the central shaft 70 (as will is further illustrated and described herein), a first light emitting device 90 secured proximate to one end of the central shaft 70, and a second light emitting device 100 secured proximate to the opposite end of the central shaft 70. The reflective element 60 is positioned to reflect any laser beam directed to the target 30 back in the direction from which it originated. In one embodiment, the reflective element 60 can be a retroreflector.

The target 30 is arranged so that it can rotate about the three spatial axes. As best illustrated in FIG. 1, the first spatial axis of rotation for the target 30 is about a vertical line (hereinafter referred to yaw) passing through the target 30, the second spatial axis of rotation is about a first horizontal line (hereinafter referred to as pitch) passing through the target 30, and the third spatial axis of rotation is about a second horizontal line, perpendicular to the first horizontal line (hereinafter referred to as roll). Such rotational movement allows the target 30 substantial freedom in its orientation. Such substantial freedom may be required when the target 30 is secured to a highly dynamic system such as an arm of a manufacturing assembly robot. As will be further described, the target 30 can be arranged to generally face in substantially the same direction during operation regardless of the six dimensional movements made by the object to which it is attached. Such functionality can provide for the target 30, and specifically the reflective element 60, to consistently face the laser unit 20 during operation. Thus, the laser unit 20 and target 30 can maintain optical communication, through the outgoing and incoming laser beams, throughout the period in which the position and rotational orientation of the object is to be determined.

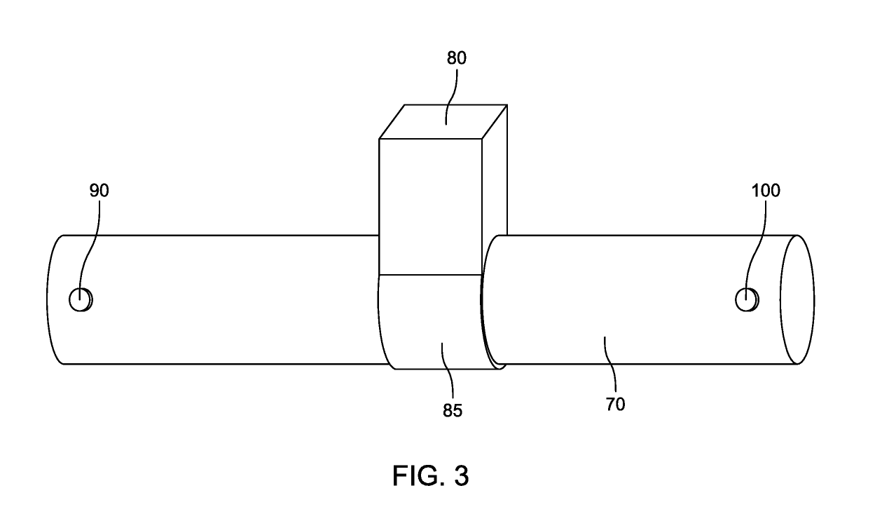

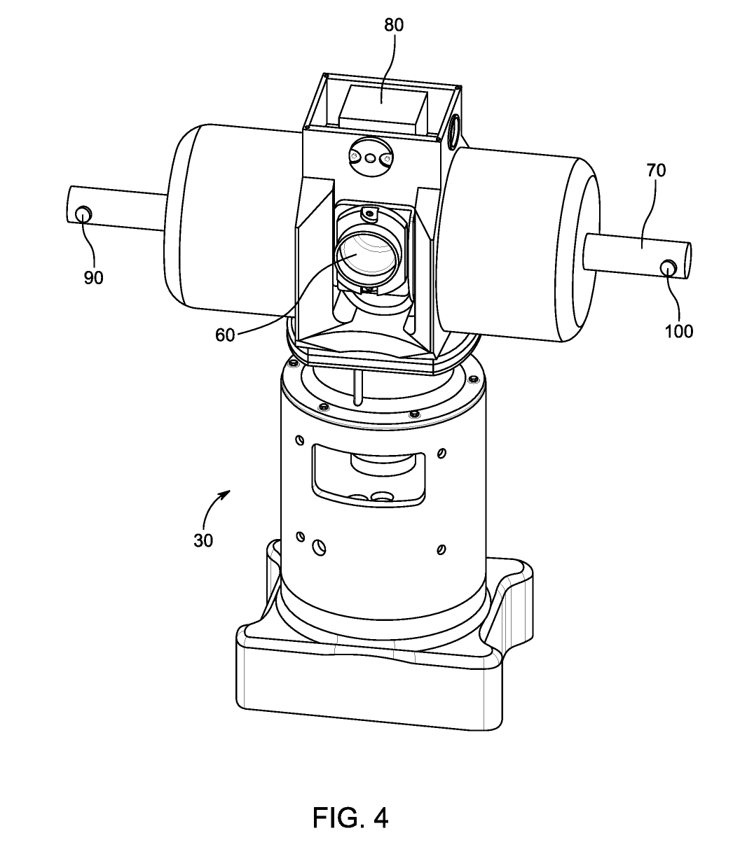

Similar to the laser unit 20, the target 30 includes a number of servo motors to rotate the target 30 about the yaw, pitch, and roll axes. The target 30 also includes a number of encoders to measure that rotation about the yaw and pitch axes. As will be understood, in the arrangement of the target 30 described herein, rotation about the roll axis is challenging to measure using an encoder. The gyroscope 80 is arranged to measure the rotation about the roll axis. As illustrated in FIGS. 3 and 4, the gyroscope 80 can be secured to the central shaft 70 and positioned within the target 30. In such an arrangement, when the target 30 rotates about the roll axis, thus rotating the central shaft 70 about the roll axis, the gyroscope 80 rotates the same amount about the roll axis. The data generated by the gyroscope 80 can then be used to determine the target's rotation about the roll axis. In one example, the gyroscope 80 can be what is commonly referred to as a micro-electro-mechanical system (MEMS) gyroscope.

While a gyroscope can generally be used to measure rotation about the roll axis, gyroscopes can be subject to a known phenomenon often referred to as “drift.” Gyroscope drift causes rotational measurements gathered by gyroscopes to become inaccurate over time. One solution is to regularly “zero out” the gyroscope by returning it to a known initial position. However, for certain applications, such as those that required continuous measurement over time, such a process may be impractical or inefficient. Therefore, the multi-dimensional measurement systems disclosed and described herein includes novel arrangements and processes for correcting in real-time errors in rotational measurement cause by gyroscope drift.

One novel arrangement and process for correcting errors in roll measurements in real-time includes the use of the first and second light emitting devices (90, 100) and the camera unit 40. In one embodiment, the first and second light emitting devices (90, 100) can be light emitting diodes (“LED”). As illustrated in FIGS. 1 through 4, the first and second light emitting devices (90, 100) can be secured to the central shaft 70 and can be spaced equally apart relative to the roll axis. In the illustrated embodiment, the first and second light emitting devices (90, 100) are positioned so there is as much separation as allowed by the length of the central shaft 70. As will be understood, as the target 30 rotates about the roll axis, the first and second light emitting devices (90, 100) will move in opposite directions with respect to both the vertical and horizontal directions. Therefore, when the light emitted from the first and second light emitting devices (90, 100) is detected, the vertical displacement, horizontal displacement, or both can be used to calculate the rotation of the target 30 about the roll axis. As will be explained in further detail herein, the information and data gathered from the servo motors, encoders, and the detection of the position of the first and second light emitting devices (90, 100) can be useful in calculating the position and rotational orientation of the object to which the target 30 is attached.

The camera unit 40 is arranged to be light sensitive. Thus, the camera unit 40 can detect and record light emitted from devices such as the first and second light emitting devices (90, 100). As will be understood, information and data gathered by the camera unit 40 can be useful in calculating the position and rotational orientation of the object. As illustrated in FIG. 1, the camera unit 40 is positioned so the lens 110 or other image capturing apparatus is directed toward the target 30 and, specifically, toward the first and second light emitting devices (90, 100). The camera unit 40 is arranged so that its field of view 120, i.e., the field across which the camera unit 40 can capture images, includes the possible locations for the first and second light emitting devices (90, 100) as the target 30 moves with the object. It will be understood that the field of view 120 is a three dimensional space, where the cross-sectional size of the field of view 120 increases as the field of view 120 projects farther away from the camera unit 40 and toward the target 30. The field of view 120 includes an optical axis passing through the center of the cross-sectional areas of the field of view 120. Provided the light emitting devices (90, 100) are in the field of view 120 of the camera unit 40, information and data gathered from the detection of the light emitting devices (90, 100) can be included in a determination position and orientation of a dynamic object in real-time. In one example, the light emitting devices (90, 100) can each include a unique property, such as intensity of light, color or light, etc., that allows the system to distinguish between the two light emitting devices (90, 100) when analyzing data and information captured by the camera unit 40.

The control unit 50 can be placed in communication with the laser unit 20, the target 30, and/or the camera unit 40 by either wired methods or wireless methods to access information and data gathered by the components of the system 10. The control unit 50 can be arranged to use such information and data to calculate the position and rotational orientation of the target 30. This position and rotational orientation of the target 30 can then be translated to calculate the position and rotational orientation of the object. The control unit 50 can also be arranged to understand the desired or correct position of the object over time, and, if the position or rotational orientation of the object is incorrect, the control unit 50 can send information and data via wired or wireless signal to the mechanism controlling the position and rotational orientation of the object to correct the object's position and rotational orientation. In the example of the object being a welding head affixed to the end of a robotic arm, the control unit 50 can include data and information on the desired position and orientation of a weld bead formed by the welding head over time. If the real-time position and rotational orientation of the weld head does not correspond the desired position and orientation of the weld bead, the control unit 50 can send a signal to the mechanism controlling the robotic arm to adjust the position and/or rotational orientation of the weld head to correspond to the desired position and orientation of the weld bead.

The following discloses a method for utilizing the system 10 and components detailed above to calculate the six degrees of freedom of the position and rotational orientation of an object. As an initial matter, the target 30 is secured to an object that will be tracked. In one example, the object would be an arm of a manufacturing robot, such as a robot designed to weld a precise metal seam on an automobile assembly line. As will be appreciated, with advancements in automobile design and manufacturing processes, automobile manufacturers are demanding more precise positioning from welding robots. Therefore, the task of tracking the welding robot and correcting any errors in its positioning and rotational orientation has become more important. The target 30 is secured to the object to be tracked in such a manner that exposes its reflective element 60 and first and second light emitting devices (90, 100) to other components of the system 10, such as the laser unit 20 and the camera unit 40.

The laser unit 20 is secured at a stationary location, with the laser beam emitting and detecting functions of the laser unit 20 directed toward and exposed to the target 30. The camera unit 40 is secured at a stationary location, with the image receiving function of the camera unit 40 directed toward and exposed to the target 30. In anticipation of the object moving, the laser unit 20 emits an outgoing laser beam 130 toward the target 30. The laser unit 20 and target 30 are arranged so that the servo motors maintain the surface of the reflective element 60 generally perpendicular to the path of the laser beam 130. Such an arrangement can be referred to as an “active target.” The reflective element 60 reflects an incoming laser beam 130 back toward the laser unit 20, where the laser unit 20 detects the incoming laser beam 130. The first and second light emitting devices (90, 100) emit light within the field of view 120 of the camera unit 40, and the camera unit 40 detects that light.

During these processes, the system 10 is gathering information and data. For example, the system 10 continuously gathers real-time information and data from servo motors and/or encoders of the laser unit 20 for use in determining the laser unit's 20 rotation about both the azimuth and elevation axes. The system 10 gathers real-time information and data on the outgoing and incoming laser beams 130 for use in calculating the distance between the laser unit 20 and the target 30. The laser beam 130 can generate information and data through techniques, such as, for example, pulsed laser configuration, repetitive time of flight pulses, phase/intensity modulation of the laser beam, or so on. The system 10 continuously gathers real-time information and data from servo motors and/or encoders of the target 30 for use in determining the target's 30 rotation about both the yaw and pitch axes. The system 10 continuously gathers real-time information and data from the gyroscope 80 for use in determining the target's 30 rotation about the roll axis. Finally, the system 10 continuously gathers information and data regarding the positions of the first and second light emitting devices (90, 100) for use in refining and confirming the target's 30 rotation about the roll axis.

With regard to the determination of the target's 30 rotation about the roll axis, it will be understood that the system 10 can use both the information and data from the gyroscope 80 and the first and second light emitting devices (90, 100) captured by the camera unit 40 to determine the target's 30 rotational orientation about the roll axis. In one exemplary method, the system 10 continuously calculates the target's 30 rotation about the roll axis using information and data gathered by the gyroscope 80. However, periodically, the system 10 calculates rotation about the target's 30 rotation about the roll axis using information and data gathered by the camera unit 40 based on light emitted from the first and second light emitting devices (90, 100). The system 10 then uses the calculated rotation about the roll to adjust or “zero out” the gyroscope 80 to correct for drift, resulting in precise calculation of the position and rotational orientation of the object. In such an example, the camera unit 40 can be an approximately 12 hertz camera unit that gathers information and data several times a second, and the system 10 applies that information and data several times a second to insure accurate and precise calculation of the position and rotational orientation of the object. In another example, the camera unit 40 may be an approximately 100 hertz, which produces even more rapid feedback from the first and second light emitting devices (90, 100) and camera unit 40 to accurately and precisely calculate the position and orientation of the object.

As noted herein, once the system 10 precisely calculates the position and rotational orientation of the object, the system can provide feedback to the mechanism controlling the movement of the object. Turning again to the example of a robotic welding arm, a welding head can be secured at the end of the welding arm. The target 30 can be attached near the welding head so that the position and rotational orientation of the target 30 can be associated or translated to the position and rotational orientation of the welding head. The system 10 can be provided with information and data that defines where the welding head should be positioned and how it should be oriented during each time increment of the welding processes. The system 10 can establish a feedback link or loop with the robotic welding machine. As the system 10 calculates the position and orientation of the welding head, the system 10 can compare that position and orientation with the optimal position and orientation of the welding head. The system 10 can provide continuous, real-time feedback to the robotic welding machine that either the welding head is where it should be or, if not, provide instructions to the robot welding machine on the difference between actual position and orientation and optimal position and orientation so that the robotic welding machine can make an appropriate adjustment.

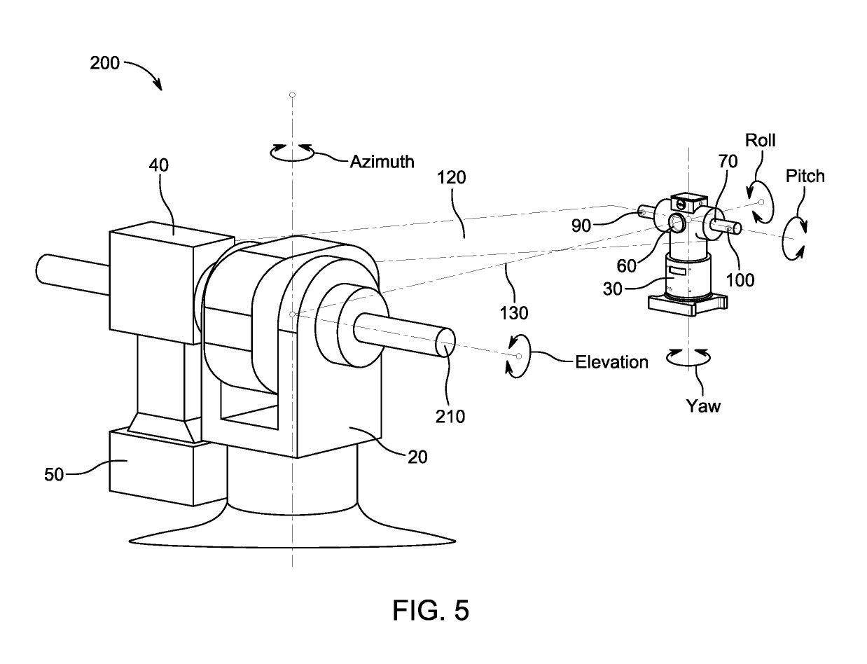

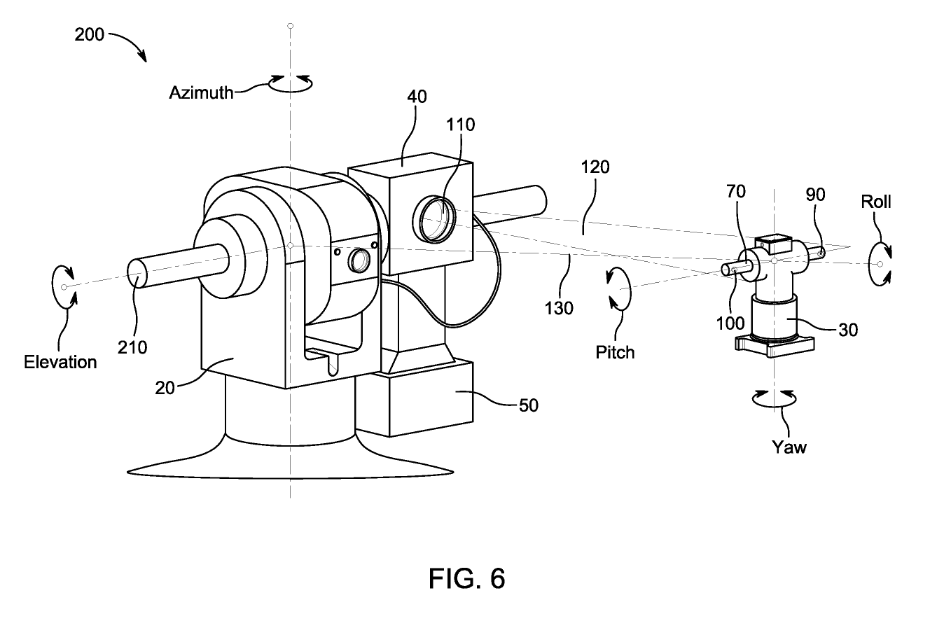

FIGS. 5 through 8 illustrate other embodiments of a measurement system. FIGS. 5 and 6 illustrate an embodiments of a measurement system 200 that joins the camera unit 40 and the control unit 50 and secures that assembly to the laser unit 20. As is illustrated, similar to the system 10 illustrated in FIG. 1, the system 200 includes a laser unit 20, a target 30, a camera unit 40 and control unit 50. Generally, the operation of the system 200 of FIGS. 5 and 6 is similar to that of the system 10 of FIG. 1. However, in the system 200 of FIGS. 3 and 4, the camera unit 40 is coupled to or otherwise affixed to the laser unit 20. The laser unit 20 and camera unit 40 are coupled to each other along the elevation axis. In one embodiment, the laser unit 20 and camera unit 40 can both be secured to a shaft 210 aligned with the elevation axis such that the laser unit 20 and camera unit 40 move together about the elevation axis. It will also be understood that when the camera unit 40 is coupled to the laser unit 20, the laser unit 20 and camera unit 40 move together about the azimuth axis as well. As a result, the optical axis of the camera unit 40 and the path of the laser beam 130 are in essence both pointed toward the reflective element 60 of the target 30. Thus, when the “active” target 30 continuously rotates and moves such that the reflective element 60 is perpendicular to the path of the outgoing laser beam 130, the light emitting devices (90 and 100) are always in the field of view 120 of the camera unit 40. As will be understood, with such an arrangement, the data and information generated by the camera unit 40 capturing images of the light emitting devices (90 and 100) will be consistently and continuously available to the control unit 50 for use in determining the position and orientation of the object.

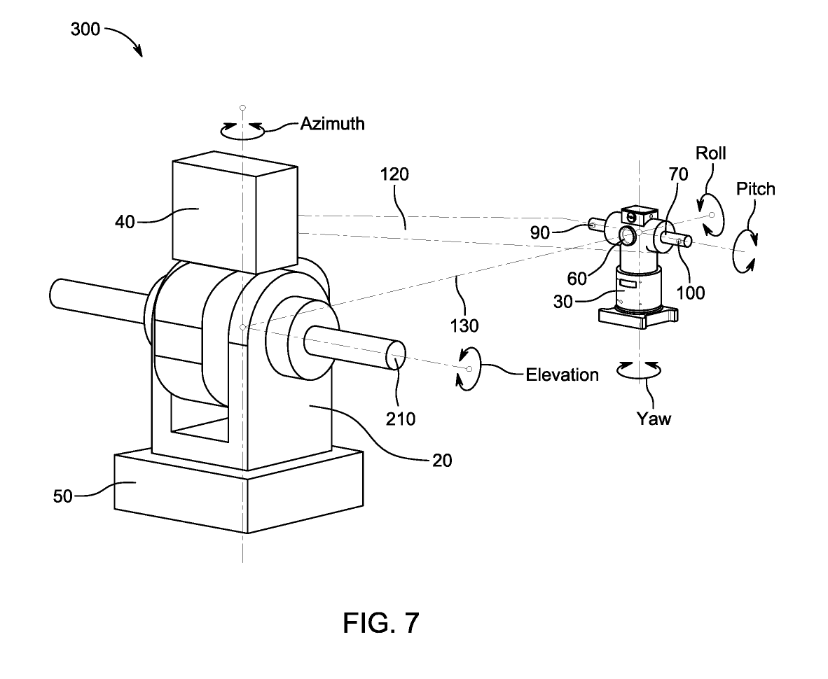

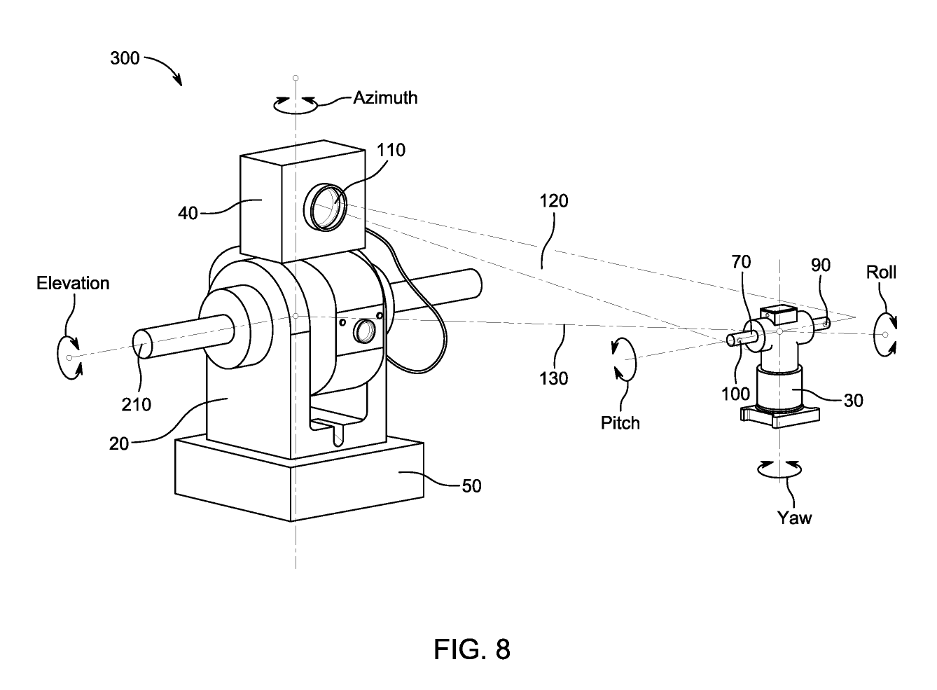

FIGS. 5 and 6 illustrate another embodiments of a measurement system 300 that joins the camera unit 40, control unit 50 to the laser unit 20. As is illustrated, similar to the systems 10 and 200 illustrated in prior figures, the system 300 includes a laser unit 20, a target 30, a camera unit 40 and control unit 50. Generally, the operation of the system 300 of FIGS. 7 and 8 is similar to that of the systems 10 and 200. However, in the system 300, the camera unit 40 is coupled directly or otherwise affixed to the laser unit 20. The laser unit 20 and camera unit 40 are coupled to each other such that the camera unit 40 movements are in sync with the movements of the laser unit 20. It will also be understood that when the camera unit 40 is coupled to the laser unit 20, the laser unit 20 and camera unit 40 move together. As a result, the optical axis of the camera unit 40 and the path of the outgoing laser beam 130 are in essence both pointed toward the reflective element 60 of the target 30. Thus, when the “active” target 30 continuously rotates and moves such that the reflective element 60 is perpendicular to the path of the outgoing laser beam 130, the light emitting devices (90 and 100) are always in the field of view 120 of the camera unit 40. As will be understood, with such an arrangement, the data and information generated by the camera unit 40 capturing images of the light emitting devices (90 and 100) will be consistently and continuously available to the control unit 50 for use in determining the position and orientation of the object.

Additional embodiments of a novel arrangements and processes for correcting in real-time errors in rotational measurement cause by gyroscope drift are illustrated in FIGS. 9-25. These novel arrangements and processes include one or more levels. In one example, the one or more levels can be MEMS levels. Levels are typically very accurate and a good complement to the use of a gyroscope to correct for drift. As will be understood, it is desirable to track objects through all possible ranges of motion, including a full 360 degree rotation about the roll axis. For example, it is not uncommon for a robotic welding head to rotate through the full 360 degrees about the roll axis while preforming welding operations on a large and complicated assembly.

Throughout the description of these embodiments and figures, several points of reference will be used to facilitate such description. For example, when discussing rotational movement about the roll axis, it will be assumed for simplicity that the target and object only rotate about the roll axis. This is to say that the rotation of the target and object are in the plane defined be the pitch and yaw axes. Additionally, the rotational movement of the target and object to be tracked about the roll axis are described with reference to the direction of the force of gravity, which will be referred to herein as the “gravitational vector” and be represented by the symbol “g.” For example, as illustrated in FIGS. 9 (perspective view) and 10 (front plan view), the target 810 is in an “initial” position. The initial position is defined as, from a front elevation view of the target 810, a centerline (CLᵥ) passing through the “height” of the target is parallel to both the gravitational vector g and the yaw axis, and a centerline (CLₕ) passing through the “width” of the target is perpendicular to the gravitational vector g. Both CLᵥ and CLₕ will be subsequently used as references to describe the rotation of the target 810 and object about the roll axis.

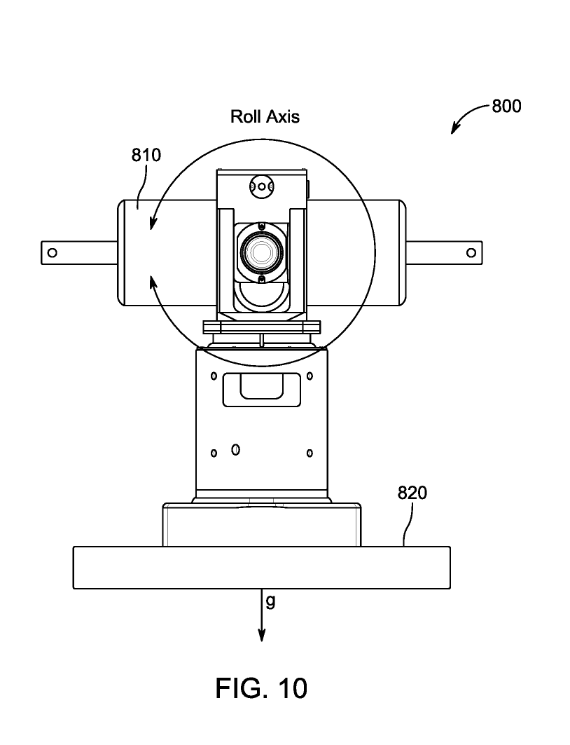

In its initial position, illustrated in FIGS. 9 and 10, the target 810 will be described as rotated 0 degrees with respect to the gravitational vector g. Additionally, the convention of “clockwise” and “counterclockwise” will be used for convenience for further description. For example, in FIG. 11, the target 810 is described as rotated 25 degrees counterclockwise with respect to the gravitation vector g, and in FIG. 12, the target is described as rotated 25 degrees clockwise with respect to the gravitational vector g.

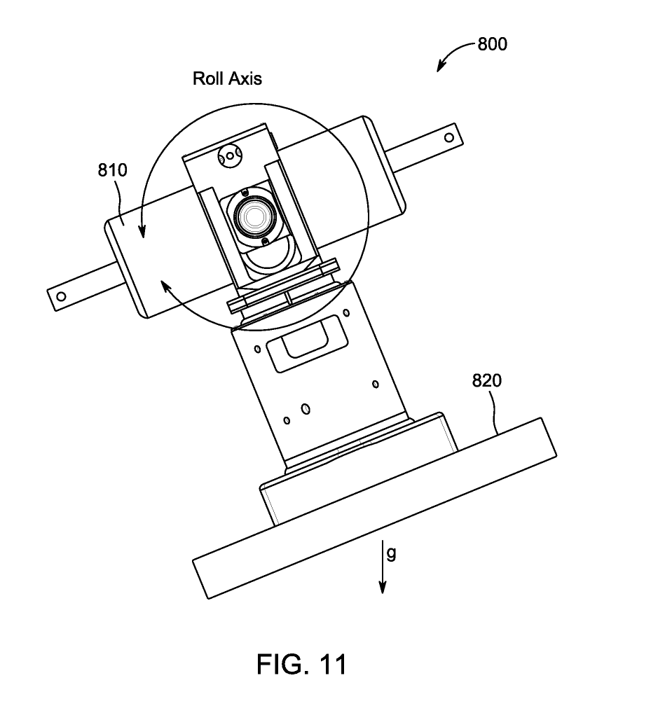

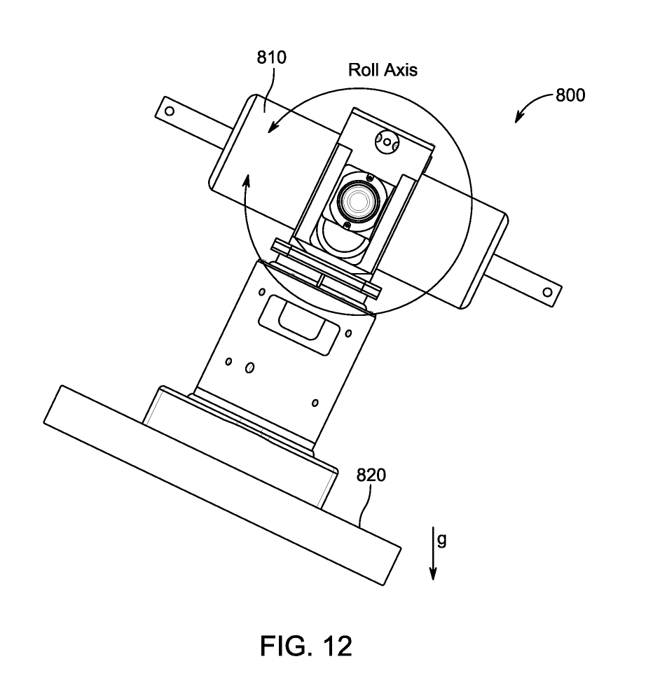

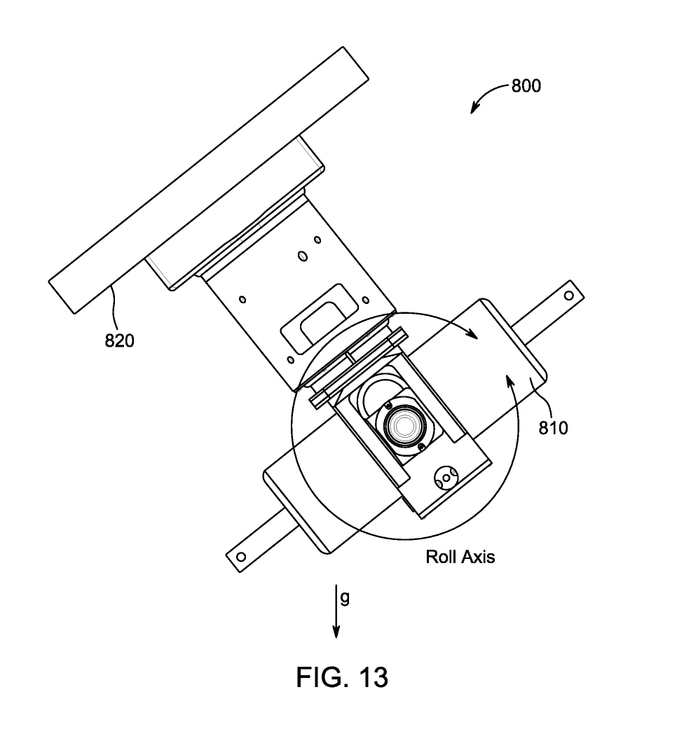

With reference to FIGS. 10-14, an assembly 800 can include a target 810 secured to a welding head 820 (shown schematically as a block for convenience). As illustrated in FIGS. 9 and 10, the target 810 is positioned in the initial position. During operation, the welding head 820 and the attached target 810 can rotate about the roll axis. As discussed previously, in FIG. 11, the welding head 820 and target 810 have rotated approximately 25 degrees counterclockwise about the roll axis, and in FIG. 12, the welding head 820 and target 810 have rotated approximately 25 degrees clockwise about the roll axis, both with respect to the gravitational vector g. Similarly, as illustrated in FIG. 13, the welding head 820 and target 810 have rotated approximately 135 degrees clockwise about the roll axis, and as illustrated in FIG. 14, the welding head 820 and target 810 have rotated approximately 145 degrees counterclockwise about the roll axis. For any application where the object tracked experiences such ranges of rotation about the roll axis, in order to fully track the movement of the object, the multi-dimensional measurement system must be arranged to measure the angular rotation about the roll axis (which can be accomplished by the gyroscope) and further correct for any drift in the gyroscope over time.

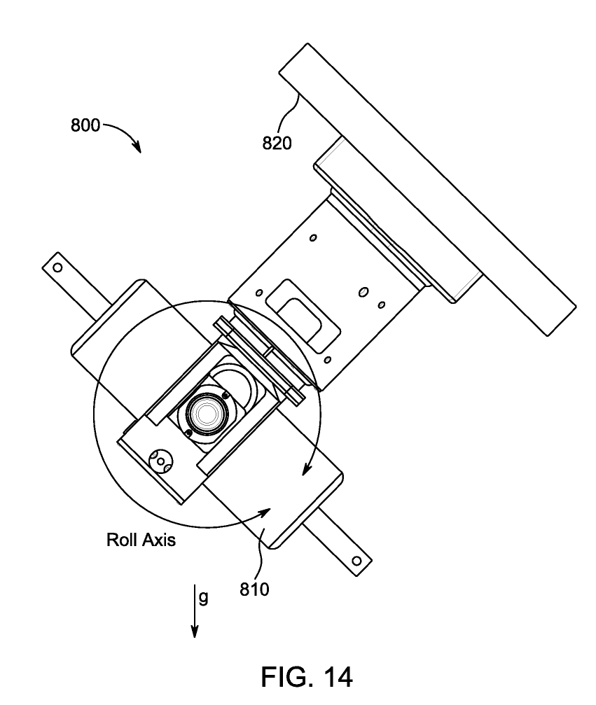

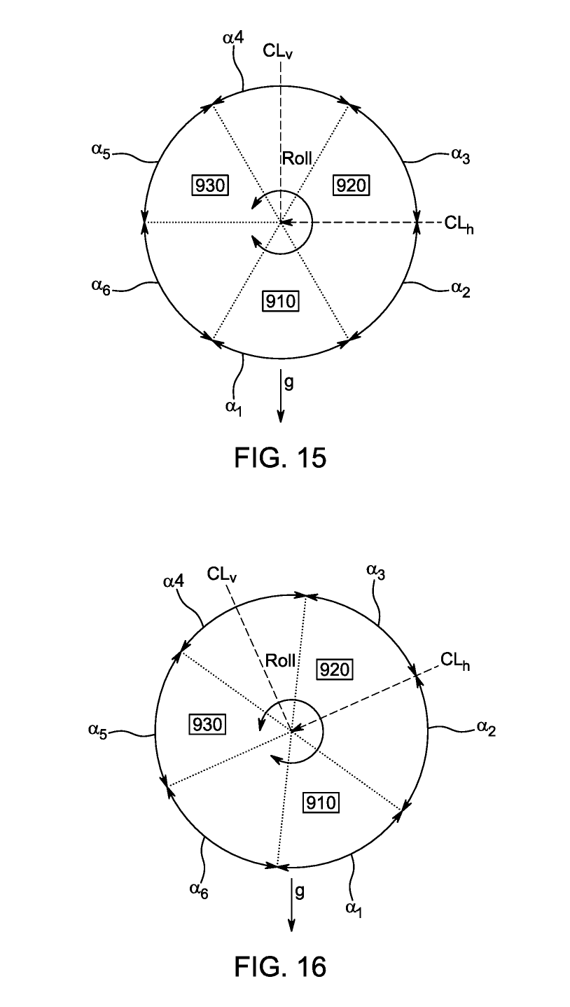

One method of correcting for gyroscope drift includes the positioning of one or more levels in the target 810. As will be described in detail, the positioning and use of the one or more levels can provide correction for gyroscope drift regardless of the rotational position of the tracked object about the roll axis. FIG. 15 schematically illustrates the positioning of three levels 910, 920, and 930 within the body of the target 810. As illustrated, all three levels 910, 920, and 930 are positioned generally in the plane defined by the yaw and pitch axes and positioned generally symmetrically about the roll axis (i.e., about 120 degrees apart about the roll axis). As will be understood, a level includes a weight that is acted on by gravity as the level rotates, and each level has a “zero” orientation, where it is in line with the gravitational vector g. When the target 810 is in the initial position, as illustrated in FIG. 15, a first level 910 is positioned such that generally in line with the gravitational vector g (i.e., in its zero orientation), a second level 920 is positioned approximately 120 degrees clockwise about the roll axis from its zero orientation, and a third level 930 is positioned approximately 120 degrees counterclockwise about the roll axis from its zero orientation. As will be further discussed, the three levels 910, 920, and 930 work cooperatively with each other and the gyroscope to accurately measure rotation about the full 360 degrees the roll axis

The operation of the levels 910, 920, and 930 will be discussed with reference to six 60 degree “rotational paths” about the roll axis. As illustrated in FIG. 15, a first rotational path α₁ is defined as a path that is between 30 degrees clockwise and 30 degrees counterclockwise with respect to the gravitational vector g; a second rotational path α₂ is defined as a path that is between 30 degrees counterclockwise and 90 degrees counterclockwise with respect to the gravitational vector g; a third rotational path α₃ is defined as a path that is between 90 degrees counterclockwise and 150 degrees counterclockwise with respect to the gravitational vector g; a fourth rotational path α₄ is defined as a path that is between 150 degrees counterclockwise and 210 degrees counterclockwise (also 150 degrees clockwise) with respect to the gravitational vector g; a fifth rotational path α₅ is defined as a path that is between 90 degrees clockwise and 150 degrees clockwise with respect to the gravitational vector g; and a sixth rotational path α₆ is defined as a path that is between 30 degrees clockwise and 90 degrees clockwise with respect to the gravitational vector g.

Levels can typically have a working range of at least 60 degrees, and can include a working range of about 70 degrees. The term “working range” refers to a rotational range where the level provides a valid reading for rotational orientation when the level is rotated no more than half its working range either clockwise or counterclockwise relative to the gravitational vector g. For a level with a 60 degree working range, it can provide a valid rotational orientation when it is rotated between 30 degrees clockwise and 30 degrees counterclockwise relative to the gravitational vector g. For a level with a 70 degree working range, it can provide a valid rotational orientation when it is rotated between 35 degrees clockwise and 35 degrees counterclockwise relative to the gravitational vector g.

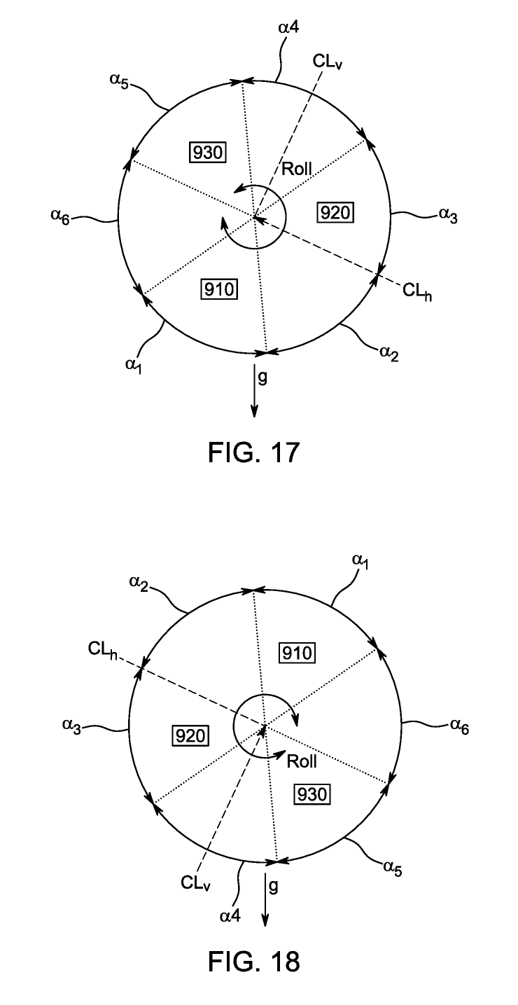

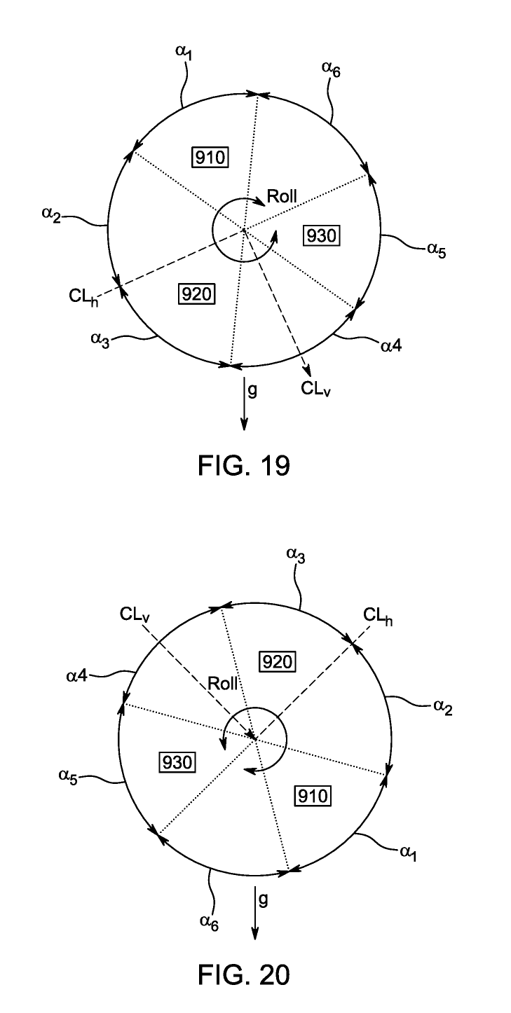

With reference to FIGS. 15-17, it will be understood that as the target 810 rotates through the first rotational path α₁ (i.e., between clockwise 30 degrees and counterclockwise 30 degrees with respect to the gravitational vector g), the first level 910 (assuming a 60 degree working range) can determine the target's rotational orientation about the roll axis. For example, as shown in FIGS. 16 and 17, when the target is rotated 25 degrees counterclockwise (as in FIG. 11 as well) or 25 degrees clockwise (as in FIG. 12 as well), the first level 910 can determine that the rotational orientations of the target are in fact 25 degrees counterclockwise and 25 degrees clockwise respectively. It will also be understood that when the target 810 rotates more than 30 degrees clockwise or 30 degrees counterclockwise with respect to the gravitational vector g, the first level 910 may be ineffective because it is outside of its working range. However, when the target 810 rotates more than 150 degrees clockwise or 150 degrees counterclockwise (the fourth rotational path α₄), as illustrated in FIGS. 18 and 19, the first level 910 again is positioned within its working range, i.e., its zero orientation is within 30 degrees rotation of the gravitational vector g. For example, in FIG. 18, the target 810 has rotated 155 degrees counterclockwise from the initial position, which positions the first level 910 within 30 degrees of its zero orientation. Thus, the first level 910 can determine that the rotational orientation of the target is in fact 155 degrees counterclockwise from its initial position. In FIG. 19, the target 810 has rotated 155 degrees clockwise from the initial position, which positions the first level 910 within 30 degrees of its zero orientation. Thus, the first level 910 can determine that the rotation of the target is in fact 155 degrees clockwise from the initial position. From the two examples provided regarding the first level 910, it will be understood that for the levels described herein, there are two rotational paths where the level's 60 degree working range is effective in determining rotational orientation, and these two rotational paths are generally located opposite to one another along the full 360 degree path of travel about the roll axis (i.e., for the first level 910, its working range is effective in rotational paths α₁ and α₄).

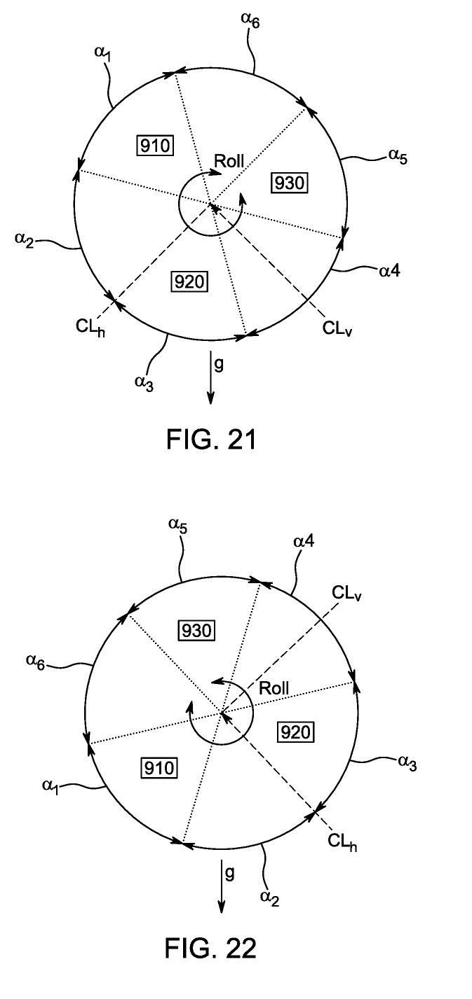

As will be understood, for the second level 920 and the third level 930, there are two rotational paths for which the level's working range is effective. As illustrated in FIG. 20, when the target 810 is rotated between 30 degrees and 90 degrees counterclockwise (rotational path α₆), the working range of the second level 920 is effective, and the second level 920 can determine the rotational orientation of the target 810 about the roll axis. As illustrated in FIG. 21, when the target 810 is rotated between 90 degrees and 150 degrees clockwise (rotational path α₃), the working range of the second level 920 is again effective, and the second level 920 can determine the rotation of the target 810 about the roll axis.

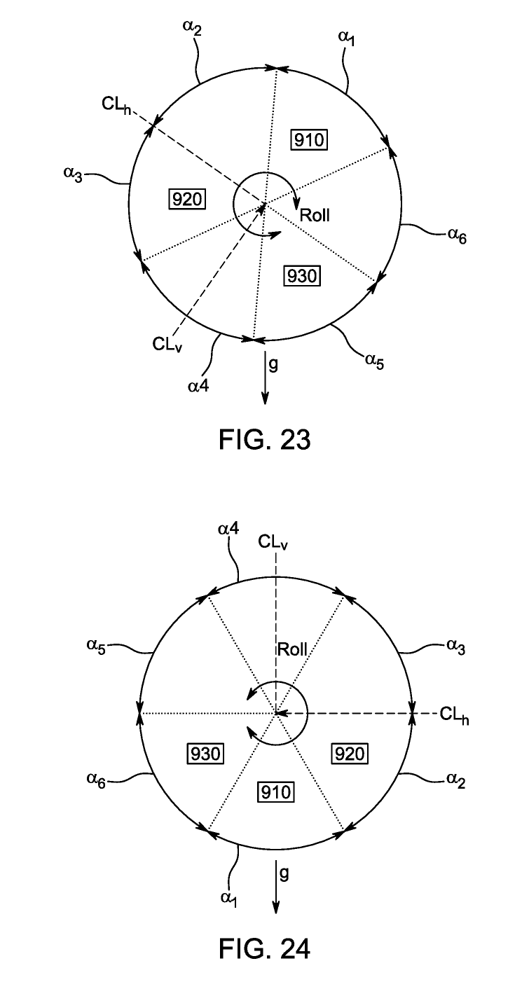

As illustrated in FIG. 22, when the target 810 is rotated between 30 degrees and 90 degrees clockwise (rotational path α₂), the working range of the third level 930 is effective, and the third level 930 can determine the rotation of the target 810 about the roll axis. As illustrated in FIG. 23, when the target 810 is rotated between 90 degrees and 150 degrees counterclockwise (rotational path α₅), the working range of the third level 930 is again effective, and the third level 930 can determine the rotation of the target 810 about the roll axis.

Another embodiment of a target with three levels incorporated into the body of the target is illustrated in FIG. 24. The first level 910 is positioned in the same location as in FIGS. 15-23. The second level 920 is positioned approximately 60 degrees clockwise to the first level 910, and the third level 930 is positioned approximately 60 degrees counterclockwise of the first level 910. In such an arrangement, the working range of the first level 910 is effective in rotational paths α₁ and α₄, the working range of the second level 920 is effective in rotational paths α₂ and α₅, and the working range of the third level 930 is effective in rotational paths α₃ and α₆.

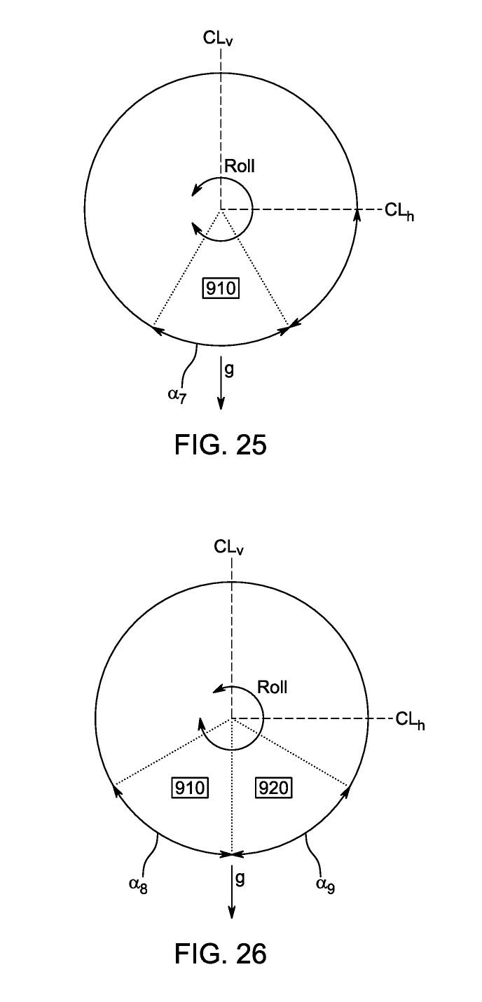

If the operational requirements of a tracking system are such that the object to be tracked will travel less than the full 360 degrees about the roll axis, then a system can be arranged with less than three levels. In one embodiment, for example, if the object to be tracked will not rotate more than 60 degrees about the roll axis, then only one level can be used. As illustrated in FIG. 25, one level 910 is positioned in the target and can determine the rotational position of the target from 30 degrees counterclockwise to 30 degrees clockwise with respect to the gravitational vector g (illustrated as rotational path α₇ in FIG. 25). In another embodiment, for example, if the object to be tracked will not rotate more than 120 degrees about the roll axis, then two level can be used. As illustrated in FIG. 26, a first level 910 and a second level 920 are positioned in the target and can determine the rotational position of the target from 60 degrees counterclockwise to 60 degrees clockwise with respect to the gravitational vector g (illustrated as rotational paths α₈ and α₉ in FIG. 26).

In order for a multi-dimensional measurement system to properly determine the rotation about the roll axis, the system must be able to distinguish between the two rotational paths where the level's working range is effective. In one example, the system can make such distinctions by closely tracking the rotational movement of the target over time. For example, as the target rotates about the roll axis, the system can determine and store data on rotational positions at short discrete time increments. The system can compare each newly determined and stored data point with the previous data point and determine if the movement is clockwise or counterclockwise or if there has been a change in the rotational movement from clockwise to counterclockwise or vice versa.

With reference to FIG. 15, if the target is rotating in a clockwise manner, as the target approaches the edge of the working range of the first level 910 (i.e., the edge of rotational path α₁), once the system detects a valid reading from the third level 930, the system can determine that the target is in rotational path as and not rotational path α₅. Similarly, if the target is rotating in a counterclockwise manner, as the target approaches the edge of the working range of the first level 910 (i.e., edge of rotational path α₁), once the system detects a valid reading from the second level 920, the system can determine that the target is in rotational path α₆ and not rotational path α₃. As will be understood, the system can continuously track the rotational orientation of the target as it rotates through the full 360 degree angle of the roll axis and dynamically determine the appropriate level to rely on and which rotational path (α₁-α₆) the target is passing through in determining the precise rotational position of the target, and thus the tracked object, about the roll axis.

As previously noted, the working range of a level can be greater than 60 degrees. In one example, the working range can be approximately 70 degrees. The additional working range can be used by the system to determine which level to rely on and which of the two rotational paths is the correct rotational path. For the arrangements illustrated in FIG. 15 and/or FIG. 24, it will be understood that the additional working range can create an overlap of about 10 degrees between adjacent rotational paths (α₁ through α₆). Such overlap can be considered by the system in determining the appropriate level to use in determining precise rotational position about the roll axis. With reference to FIG. 15, if the target is rotating in a clockwise manner, as the target approaches the edge of the working range of the first level 910 (i.e., the edge of rotational path α₁), the system also detects a valid reading from the third level 930. Thus, as the target continues to rotate clockwise, the system can determine that the target is in rotational path as and not rotational path α₅. Similarly, if the target is rotating in a counterclockwise manner, as the target approaches the edge of the working range of the first level 910 (i.e., the edge of rotational path α₁), the system also detects a valid reading from the second level 920. Thus, as the target continues to rotate counterclockwise, the system can determine that the target is in rotational path α₆ and not rotational path α₃. As will be understood, the system can continuously track the rotational orientation of the target as it rotates through the full 360 degree angle of the roll axis and dynamically determine the appropriate level and the appropriate rotational path to rely on in determining the precise rotational position of the target, and thus the tracked object, about the roll axis.

In another embodiment, the light emitting devices and the camera can be used to identify the appropriate level and rotational path to rely on when determining the rotational orientation of the target about the roll axis. As previously described, the camera can capture images of the target, including the light emitting devices to determine the rotational orientation of the target. It will be understood that the system can use the information and data generate by the camera to determine the general rotational orientation of the target over time, and use such information to identify the appropriate level and rotational path to rely on. To the extent that the level provides more precise readings than can be ascertained from the information and data generated by the camera, such a method can result in more precise determination of the rotational orientation of the target, and thus the tracked object, about the roll axis.

While numerous embodiments of exemplary multi-dimensional measurement systems are described and illustrated herein, the examples are not exhaustive. The components of multi-dimensional measurement systems can be arranged in any number of ways and combinations. However, in any arrangements where data and information derived from light emitting devices is to be considered in determining the rotation of a target about its roll axis, and thus determining the position and orientation of the target, the light emitting devices associated with the target are to be in the field of view of a camera unit when such data and information is to be considered.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A system for determining the position and orientation of an object, comprising:
a laser unit, comprising:
a laser emitting device; and
a laser detecting device;
a target coupled to the object, the target comprising:
a reflective element;
a gyroscope;
a first light emitting device; and
a second light emitting device;
a camera unit; and
a control unit.

2. The system of claim 1, wherein:
the laser unit further comprising:
a first rotating device to rotate the laser unit about an elevation axis;
a second rotating device to rotate the laser unit about an azimuth axis;
a first angular detection device to measure the rotation of the laser unit about the elevation axis; and
a second angular detection device to measure the rotation of the laser unit about the azimuth axis; and
the target further comprising:
a third rotating device to rotate the target about a pitch axis;
a fourth rotating device to rotate the target about a yaw axis;
a fifth rotating device to rotate the target about a roll axis;
a third angular detection device to measure the rotation of the target about the pitch axis; and
a fourth angular detection device to measure the rotation of the target about the yaw axis.

3. The system of claim 2, wherein the gyroscope is arranged to measure the rotation of the target about the roll axis.

4. The system of claim 3, wherein the camera unit is arranged to capture light emitted from the first light emitting device and the second light emitting device.

5. The system of claim 4, wherein the control unit is arranged to accept data and information from the laser unit, the target, and the camera unit.

6. The system of claim 5, wherein the control unit is arranged to determine the rotation of the target about the roll axis.

7. The system of claim 6, wherein the control unit is arranged to determine the position and orientation of the object from the information received from the laser unit, the target, and the camera unit.

8. The system of claim 7, where the orientation of the object about the roll axis is determined from the data and information measured by the gyroscope and data and information captured by the camera unit from light emitted from the first light emitting device and the second light emitting device.

9. The system of claim 1, wherein the system further comprises a first shaft and a second shaft.

10. The system of claim 9, wherein the first shaft is positioned along the elevation axis of the laser unit and couples the laser unit to the camera unit.

11. The system of claim 9, wherein the second shaft is positioned along the pitch axis of the target.

12. The system of claim 11, wherein the reflective element, the gyroscope, the first light emitting device, and the second light emitting device are each coupled to the second shaft.

13. The system of claim 12, wherein the first light emitting device is coupled proximate to a first end of the second shaft and the second light emitting device is coupled proximate to a second end of the second shaft.

14. The system of claim 13, wherein the first light emitting device and the second light emitting device are light emitting diodes.

15. The system of claim 1, wherein the control unit is in wireless communication with the laser unit, the target, and camera unit.

16. The system of claim 1, wherein the control unit is arranged send a signal with information and data to adjust the position and orientation of the object.

17. The system of claim 1, wherein laser emitting device emits a laser beam toward the reflective element and the laser detecting device detects the laser beam reflected from the reflective element.

18. The system of claim 1, wherein the target is arranged such that the reflective element remains perpendicular to laser beams emitted from the laser emitting device.

19. The system of claim 2, wherein the first rotating device, second rotating device, third rotating device, fourth rotating device, and fifth rotating device are servo motors.

20. The system of claim 2, wherein the first angular detection device, second angular detection device, third angular detection device, and fourth angular detection device are encoders.

21. A system for determining the position and orientation of an object, comprising:
a laser unit, comprising:
a laser emitting device; and
a laser detecting device;
a target coupled to the object, the target comprising:
a reflective element;
a gyroscope;
at least one level; and
a control unit.

22. The system of claim 21, wherein:
the laser unit further comprising:
a first rotating device to rotate the laser unit about an elevation axis;
a second rotating device to rotate the laser unit about an azimuth axis;
a first angular detection device to measure the rotation of the laser unit about the elevation axis; and
a second angular detection device to measure the rotation of the laser unit about the azimuth axis; and
the target further comprising:
a third rotating device to rotate the target about a pitch axis;
a fourth rotating device to rotate the target about a yaw axis;
a fifth rotating device to rotate the target about a roll axis;
a third angular detection device to measure the rotation of the target about the pitch axis; and
a fourth angular detection device to measure the rotation of the target about the yaw axis.

23. The system of claim 22, wherein the gyroscope is arranged to measure the rotation of the target about the roll axis.

24. The system of claim 23, wherein the at least one level is arranged to measure the rotation of the target about the roll axis.

25. The system of claim 24, wherein the control unit is arranged to accept data and information from the laser unit and the target.

26. The system of claim 25, where the orientation of the object about the roll axis is determined from the data and information measured by the gyroscope and data and information captured measured by the at least one level.

27. The system of claim 26, wherein the at least one level includes a first level and a second level, where the first level and second level are spaced apart from one another about the roll axis.

28. The system of claim 26, wherein the at least one level includes a first level, a second level, and a third level where the first level, second level, and third level are proportionally spaced apart from one another about the roll axis.

29. The system of claim 28, where the system is arranged to determine which of the first, second, or third level is to be relied on in determining the orientation of the target about the roll axis.
